(19) United States
(12) Patent Application Publication
(10) Pub. No.: US 2022/0144980 A1
(43) Pub. Date: May 12, 2022

(54) CURED PRODUCT OF CURABLE MATERIAL, METHOD FOR PRODUCING CURED PRODUCT, AND POLYMER COMPOSITION

(71) Applicant: NAGASE CHEMTEX CORPORATION, Osaka-shi, Osaka (JP)

(72) Inventors: Kazuki YOSHINO, Tatsuno (JP); Keiji WATANABE, Tatsuno-shi (JP)

(73) Assignee: NAGASE CHEMTEX CORPORATION, Osaka-shi, Osaka (JP)

(21) Appl. No.: 17/434,124

(22) PCT Filed: Feb. 26, 2020
(86) PCT No.: PCT/JP2020/007621

§ 371 Date: Aug. 26, 2021

(30) Foreign Application Priority Data
Feb. 26, 2019 (JP) 2019-033266

(51) Int. Cl. C08F 26/06; C08F 36/14

(52) U.S. Cl. CPC C08F 26/06; C08F 36/14

(57) ABSTRACT

A cured product of a curable material is a cured product of a curable material containing a benzoxazine compound and a polymerization initiator. The benzoxazine compound has a polymerizable functional group on a nitrogen atom constituting an oxazine ring. The cured product has a curing rate of 60% or more. The present invention also encompasses a polymer composition including a polymer including repeating units of a polymerizable monomer having a benzoxazine ring.

### TECHNICAL FIELD

The present invention relates to a cured product of a curable material containing a benzoxazine compound, a method for producing the cured product, and a polymer composition including repeating units of a polymerizable monomer having a benzoxazine ring.

### BACKGROUND ART

A benzoxazine compound is cured by ring-opening polymerization of an oxazine ring by the action of heat. The resulting cured product has excellent physical properties such as a high glass transition point (Tg), high heat resistance, high flame retardancy, and high dimensional stability, as well as a low dielectric constant, and a low water absorption rate. For this reason, studies have been conducted on utilization of benzoxazine compounds as thermosetting materials in various applications. For example, PTLs 1 and 2 propose using, for a prepreg or the like, a resin composition that uses a compound having a benzoxazine ring. PTL 3 proposes a thermosetting resin containing a polymer of a benzoxazine derivative.

### CITATION LIST

### Patent Literatures

### [PTL 1] WO 2014/004900

### [PTL 2] WO 2010/092723

### [PTL 3] Japanese Laid-Open Patent Publication No. 2002-302486

### SUMMARY OF INVENTION

### Technical Problem

Although benzoxazine compounds are excellent in various physical properties, they have either a high melting point or a high viscosity and thus are inferior in handleability. It is considered that the viscosity of a thermosetting material can be reduced by using a monofunctional compound. However, using a monofunctional compound results in a reduction in mechanical properties due to fewer crosslinking point. In addition, a monofunctional compound is likely to be decomposed or vaporized during heat curing, thus producing bubbles (voids) in a cured product.

### Solution to Problem

An aspect of the present invention relates to a cured product of a curable material,

the curable material containing a benzoxazine compound and a polymerization initiator,

wherein the benzoxazine compound has a polymerizable functional group on a nitrogen atom constituting an oxazine ring, and

the cured product has a curing rate of 60% or more.

Another aspect of the present invention relates to a method for producing a cured product of a curable material: including:

a first step of heating or exposing to light, at a first temperature of less than 180° C., a curable material containing a benzoxazine compound having a polymerizable functional group on a nitrogen atom constituting an oxazine ring, and a polymerization initiator, thereby reacting the polymerizable functional group; and

a second step of heating a reaction product obtained in the first step at a second temperature that is higher than 150° C. and higher than the first temperature, to allow a curing reaction to proceed by ring opening of the oxazine ring, thereby obtaining a cured product.

Yet another aspect of the present invention relates to a polymer composition including a polymer including repeating units of a polymerizable monomer having a benzoxazine ring.

### Advantageous Effects of Invention

It is possible to provide a method for producing a cured product of a curable material containing a benzoxazine compound, a cured product, and a polymer composition that can ensure high mechanical properties and suppress the generation of voids in the cured product.

### DESCRIPTION OF EMBODIMENTS

While the novel features of the invention are set forth in the appended claims, the invention, both as to organization and content, will be better understood and appreciated, along with other objects and features thereof, from the following detailed description taken in conjunction with the drawings.

Benzoxazine compounds commonly used as thermosetting materials are multifunctional and have a high melting point (more specifically, are often solid at room temperature (20° C. or more and 35° C. or less)) or have a high viscosity, and thus are difficult to handle. Among benzoxazine compounds having a low viscosity, a monofunctional benzoxazine compound undergoes a reduction in crystallinity, molecular weight, and/or polarity, for example, and therefore can reduce the viscosity of the thermosetting material. However, it is difficult to obtain a cured product having a curing rate of 60% or more. Using a monofunctional benzoxazine compound results in fewer crosslinking points, so that the mechanical properties are reduced. In addition, using a monofunctional benzoxazine compound reduces the Tg of the cured product, resulting in a reduction in the heat resistance. Furthermore, the present inventor has found that using a monofunctional benzoxazine compound is likely to cause decomposition and/or vaporization during heat curing, so that voids may be generated in the cured product. In a curing reaction of the benzoxazine compound, an iminium intermediate is produced by ring opening of the oxazine ring. It is considered that gas is generated by elimination and vaporization of iminium caused by a substituent on a nitrogen atom, which is derived from the nitrogen atom of the oxazine ring, of the iminium intermediate, resulting in generation of voids in the cured product. The occurrence of such decomposition of the benzoxazine compound makes it difficult for the curing reaction to proceed, which also causes a reduction in the mechanical properties of the cured product.

A cured product of a curable material according to an aspect of the present invention is a cured product of a curable material containing a benzoxazine compound and a polymerization initiator, wherein the benzoxazine compound has a polymerizable functional group (first polymerizable functional group) on a nitrogen atom constituting an oxazine ring. The cured product has a curing rate of 60% or more.

On the other hand, it is possible to ensure a curing rate of 60% or more by using a production method including: a first step of heating or exposing to light, at a first temperature of less than 180° C., a curable material containing a benzoxazine compound having a first polymerizable functional group on a nitrogen atom constituting an oxazine ring, and polymerization initiator, thereby reacting the first polymerizable functional group; and

a second step of heating a reaction product obtained in the first step at a second temperature that is higher than 150° C. and higher than the first temperature, to allow a curing reaction to proceed by ring opening of the oxazine ring, thereby obtaining a cured product.

Such a high curing rate can be achieved by performing the reaction of the first polymerizable functional group and the ring-opening reaction of the oxazine ring under conditions that are respectively suitable for these reactions. Even when the benzoxazine compound has only one oxazine ring in the molecule, it is possible to increase the curing rate by allowing both of the reaction of the first polymerizable functional group and the ring-opening reaction of the oxazine ring to proceed. Accordingly, it is possible to ensure high mechanical properties (specifically, mechanical strength) of the cured product. Since a high curing rate can be ensured, the Tg of the cured product can be increased, making it also possible to ensure high heat resistance. Since the benzoxazine compound has the polymerizable functional group on the nitrogen atom constituting the oxazine ring, and the first polymerizable functional group is reacted in the first step, it is possible to suppress the decomposition of the benzoxazine compound due to heating, thus increasing the molecular weight. Accordingly, the generation of gas due to decomposition and/or vaporization of the benzoxazine compound is suppressed. Thus, the generation of voids in the cured product is suppressed.

Even when the same benzoxazine compound is used, with a conventional method that involves curing the benzoxazine compound under conditions in which a ring-opening reaction of an oxazine ring proceeds, it is not possible to allow the reaction of the first polymerizable functional group to proceed sufficiently, resulting in a curing rate of less than 60%. Therefore, it is difficult to ensure high mechanical properties of the cured product, and the heat resistance is also reduced. When the benzoxazine compound has only one oxazine ring in the molecule, the mechanical properties and the heat resistance are particularly likely to be reduced.

The present invention also encompasses a polymer composition including a polymer including repeating units of a polymerizable monomer having a benzoxazine ring. Such a polymer composition is obtained by allowing the reaction of the first polymerizable functional group of the polymerizable monomer to proceed preferentially to the ring-opening reaction of the benzoxazine ring. For example, the polymer composition encompasses a composition obtained by the first step of the above-described production method of a cured product. Using such a polymer composition allows the ring-opening reaction of the oxazine ring to easily proceed by heating, and also can easily increase the curing rate of the cured product. As a result, it is possible to ensure high mechanical properties of the cured product. It is also possible to ensure high heat resistance of the cured product. Since the decomposition and/or vaporization of the polymerizable monomer is suppressed due to the reaction of the first polymerizable functional group being allowed to proceed preferentially, the polymer composition is useful to obtain a cured product in which the generation of voids is suppressed.

The benzoxazine ring has a structure in which a benzene ring is fused to an oxazine ring (specifically, a 1,3-oxazine ring). The benzoxazine ring has an oxygen atom in the 1-position and a nitrogen atom in the 3-position, and has the first polymerizable functional group on the nitrogen atom (i.e., the nitrogen atom in the 3-position) constituting the ring.

The curing rate (or reaction rate) of the cured product is determined by measuring the amount of heat generation E₁ per unit mass of 10 mg of a test strip of the cured product by differential scanning calorimetry (DSC), and obtaining a curing rate from the E₁ and a pre-measured amount of heat generation E₀ per unit mass necessary for complete cure of the curable material, using the following formula:

Curing rate (%)=(1−E₁/E₀)×100

Note that the amount of heat generation E₀ necessary for complete cure of the curable material is the amount of heat generation per unit mass of 10 mg of the uncured curable material measured by DSC. The DSC is performed in a temperature range of 30 to 350° C., under an temperature rising condition of 10° C./min.

Note that the first polymerizable functional group is a functional group that participates in the polymerization of a benzoxazine compound other than the oxazine ring. The first polymerizable functional group can be reacted by radicals, cations, or anions generated from the polymerization initiator.

In the following, the cured product of the curable material, the method for producing the cured product, and the polymer composition will be described more specifically.

### [Cured Product of Curable Material]

The cured product is a cured product of a curable material containing a benzoxazine compound and a polymerizable initiator.

### (Curable Material)

(Benzoxazine Compound)

The benzoxazine compound contained in the curable material has a first polymerizable functional group on a nitrogen atom constituting an oxazine ring. Due to the presence of the first polymerizable functional group in such a position, the generation of voids in the cured product can be more easily suppressed without preventing ring opening of the oxazine ring. The curable material may contain one benzoxazine compound, or may contain two or more benzoxazine compounds.

The benzoxazine compound may have one benzoxazine ring (or skeleton) in one molecule, or may have two or more benzoxazine rings (or skeletons) in one molecule. When the benzoxazine compound has two or more benzoxazine rings, the benzoxazine compound may have the first polymerizable functional group in the oxazine ring of at least one benzoxazine ring, or may have the first polymerizable functional group(s) in part or all of the oxazine rings of two or more benzoxazine rings. When the benzoxazine compound has two or more first polymerizable functional groups, part or all of the first polymerizable functional groups may be the same, or all of the first polymerizable functional groups may be different. The number of benzoxazine rings in the benzoxazine compound is, for example, 4 or less, and may be 3 or less, but is preferably 2 or less, from the viewpoint of suppressing an excessive increase in the viscosity of the curable material.

When the benzoxazine compound has two or more benzoxazine rings, the benzoxazine rings may be linked by a direct bond, or may be linked via a linking group (first linking group). The first linking group may be bonded to the oxazine ring or the benzene ring of each of the benzoxazine ring. Examples of the first linking group include a multivalent group having the number of binding sites corresponding to the number of benzoxazine rings. Examples of such multivalent groups include, but are not limited to, an ether bond (—O—), a thioether bond (—S—), a sulfonyl group (—SO₂—), an ester bond (—C(═O)—O—), a multivalent group corresponding to a hydrocarbon (e.g., alkane, arene, alkyl arene, dialkyl arene, etc.), a multivalent group corresponding to a heterocycle, and a multivalent group corresponding to a polyarene. Examples of the polyarene include a plurality of arene rings linked by a direct bond, an ether bond, a thioether bond, a sulfonyl group, an ester bond, or a multivalent group corresponding to an alkane. The first linking group (a hydrocarbon, a heterocycle, etc.) may have a substituent (a halogen atom, a hydroxy group, a mercapto group, and/or an amino group, etc.) as needed.

Preferably, the curable material contains, as the benzoxazine compound, at least a compound having one benzoxazine ring in one molecule. In this case, the viscosity of the curable material can be kept low, making it possible to enhance the handleability of the curable material. According to the above-described aspect of the present invention, it is possible to ensure a high curing rate by preferentially reacting the first polymerizable functional group. Accordingly, even in the case of using a compound having one benzoxazine ring in this manner, it is possible to ensure high mechanical properties and high heat resistance of the cured product, and suppress the generation of voids. It is also possible to combine a benzoxazine compound having one benzoxazine ring in one molecule with a benzoxazine compound having two or more benzoxazine rings in one molecule.

Examples of the first polymerizable functional group include, but are not particularly limited to, a group having a polymerizable carbon-carbon unsaturated bond, an epoxy group, an isocyanate group, a hydroxy group, a mercapto group, an amino group, a ureido group, a carboxy group, a sulfonic acid group, an acid chloride group, and a chlorine atom. The epoxy group, the isocyanate group, the hydroxy group, the mercapto group, the amino group, the ureido group, the carboxy group, the sulfonic acid group, the acid chloride group, and the chlorine atom may be each bonded to the benzoxazine compound via a linking group (second linking group). The amino group may be either a —NH₂ group or a >NH group. Examples of the second linking group include a divalent organic group. Examples of the organic group include a hydrocarbon group (an aliphatic hydrocarbon group (an alkylene group, an alkenylene group, etc.), an alicyclic hydrocarbon group (a cycloalkylene group, a divalent group corresponding to a dialkyl cycloalkane, etc.), an aromatic hydrocarbon group (an arylene group, etc.), an aliphatic hydrocarbon group (an alkylene group, an alkenylene group, etc.) having an alicyclic hydrocarbon ring (a cycloalkane, etc.) or an aromatic hydrocarbon ring (an arene, etc.) etc.), an oxyalkylene group, a polyoxyalkylene group, a carbonyl group, an oxycarbonyl group, —NH—C(═O)—, a heterocyclic group, and an aliphatic hydrocarbon group (an alkylene group, an alkenylene group, etc.) having a heterocycle. Examples of the heterocycle constituting the heterocyclic group and examples of the heterocycle of the aliphatic hydrocarbon include 4- to 10-membered heterocycles having a heteroatom (a nitrogen atom, an oxygen atom, and/or a sulfur atom, etc.).

Examples of the group having a polymerizable carbon-carbon unsaturated bond include a vinyl group, an allyl group, an alkenyl group, a dienyl group, an acryloyloxyalkyl group, a methacryloyloxyalkyl group, an acrylaminoalkyl group, and a methacrylaminoalkyl group. The number of carbon atoms in the group having a polymerizable carbon-carbon unsaturated bond is 2 or more. From the viewpoint of enhancement of the effect of suppressing the generation of voids in the cured product, the curable material preferably contains at least a group having a polymerizable carbon-carbon unsaturated bond having three or more (particularly four or more) carbon atoms. The number of carbon atoms in the group having a polymerizable carbon-carbon unsaturated bond is, for example, 16 or less, and may be 10 or less. These lower and upper limit values can be combined in any combination. Note that, as used in the present specification, acryloyloxy and methacryloyloxy may be collectively referred to as (meth)acryloyloxy. Also, acrylamino and methacrylamino may be collectively referred to as (meth)acrylamino.

The number of carbon atoms in the group having a polymerizable carbon-carbon unsaturated bond may be 2 or more and 16 or less (or 10 or less), 3 or more and 16 or less (or 10 or less), or 4 or more and 16 or less (or 10 or less).

Among these, when the first polymerizable functional group is at least one selected from the group consisting of (meth)acryloyloxyalkyl and (meth)acrylaminoalkyl, the effect of suppressing the generation of voids is high, so that the benzoxazine compound can be easily synthesized or procured. From the viewpoint of further enhancement of the effect of suppressing the generation of voids, the alkyl groups respectively constituting (meth)acryloyloxyalkyl and (meth)acrylaminoalkyl are, for example, preferably C₁₋₆ alkyl (methyl, ethyl, propyl, 2-propyl, etc.), and more preferably C₁₋₄ alkyl.

The benzoxazine compound may have the first polymerizable functional group only on the nitrogen atom constituting the oxazine ring. The benzoxazine compound may further have a first polymerizable functional group in a position other than the nitrogen atom (specifically, the 2-, 4-, 5-, 6-, 7-, and/or 8-position of the benzoxazine ring), in addition to the first polymerizable functional group on the nitrogen atom constituting the oxazine ring of the benzoxazine ring.

The benzoxazine compound may have a substituent (first substituent) other than the first polymerizable functional group. Examples of the first substituent include a hydrocarbon group, an alkoxy group, an alkoxycarbonyl group, a carboxy group or a salt thereof (a salt with an inorganic base (a metal salt, an ammonium salt, etc.), a salt with an organic base, etc.), an acyloxy group, a hydroxy group, a mercapto group, an amino group, an alkylamino group, an acylamino group, a carbamoyl group, an alkylcarbamoyl group, a cyano group, and a halogen atom (a fluorine atom, a chlorine atom, a bromine atom, an iodine atom, etc.). Examples of the hydrocarbon group include an aliphatic hydrocarbon group (an alkyl group, etc.), an alicyclic hydrocarbon group (a cycloalkyl group, etc.), and an aromatic hydrocarbon group (an aryl group, etc.). The alkoxy group, the alkoxycarbonyl group, the acyloxy group, and the acylamino group may each be aliphatic, alicyclic, or aromatic. Examples of the alkyl group and the alkyl group constituting the alkylamino group and the alkylcarbamoyl group include C₁₋₆ alkyl (methyl, ethyl, propyl, 2-propyl, butyl, etc.). Examples of the alkoxy group and the alkoxy group constituting the alkoxycarbonyl group include a C₁₋₆ alkoxy group (methoxy, ethoxy, propoxy, 2-propoxy, butoxy, etc.). Examples of the acyl group constituting the acyloxy group and the acylamino group include a C₂₋₆ acyl group (an acetyl group, a propionyl group, etc.).

Among the first substituents, the hydrocarbon group, the alkoxy group, the alkoxycarbonyl group, the acyloxy group, the alkylamino group, the acylamino group, and the alkylcarbamoyl group may each further have a substituent (second substituent). The second substituent can be selected from the above listed examples of the first substituent. Among these, the second substituent may be a hydroxy group, a mercapto group, an amino group, a carboxy group or a salt thereof, a cyano group, or a halogen atom (a fluorine atom, a chlorine atom, a bromine atom, an iodine atom, etc.). The number of second substituents per one first substituent is not particularly limited, but is, for example, 1 to 4, and may be 1 or 2.

The number of first substituents (which may have a second substituent) in the benzoxazine compound is not particularly limited, and the benzoxazine compound may have one first substituent, or may have two or more first substituents. When the benzoxazine compound has two or more first substituents, the first substituents may be the same, or part or all of the first substituents may be different. The number of first substituents (which may have a second substituent) in the benzoxazine compound per one benzoxazine ring may be 0, 1, or 2 or more. The number of the first substituents is, for example, 6 or less, and may be 5 or less. These lower and upper limit values can be combined in any combination.

The position of the first substituent is, for example, the 2-, 4-, 5-, 6-, 7-, and/or 8-position of the benzoxazine ring. Note that these positions are based on the assumption that the oxygen atom constituting the oxazine ring is in the 1-position. Among these, the 5- and/or 6-position is preferable from the viewpoint of ease of synthesis and procurement of the benzoxazine compound.

The first substituent may be a monovalent substituent such as the ones described above, but may constitute a ring, together with an atom (e.g., the carbon atom in the 5-, 6-, or 7-position) constituting the benzoxazine ring substituted by the first substituent, and an atom adjacent to the aforementioned atom.

Preferably, the benzoxazine compound includes, for example, a compound represented by the following formula (1) and/or a compound represented by the following formula (2).

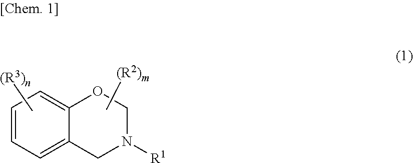

where R¹ is a first polymerizable functional group, or a second linking group having a first polymerizable functional group, R² and R³ are each a first substituent (which may have a second substituent), m is 0, 1 or 2, and n is an integer of 0 to 4.

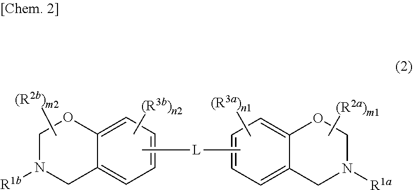

where L is a first linking group, R^{1a} and R^{1b} are the same or different and each are a first polymerizable functional group, or a second linking group having a first polymerizable functional group, R^{2a} and R^{2b} are the same or different and are each a first substituent (which may have a second substituent), R^{3a} and R^{3b} are the same or different and are each a first substituent (which may have a second substituent), m1 and m2 are the same or different and are each 0, 1 or 2, and n1 and n2 are the same or different and are each an integer of 0 to 4.

The proportion of the benzoxazine compound in the curable material can be determined, for example, according to the type of the first polymerizable functional group and the use of the cured product. The proportion of the benzoxazine compound in the curable material is, for example, 5 mass % or more or 10 mass % or more, and may be 20 mass % or more or 50 mass % or more, or 80 mass % or more.

As the benzoxazine compound, a commercially available product may be used, or a compound synthesized by a known method may be used. For example, the benzoxazine compound represented by the formula (1) can be synthesized by reacting a phenol compound, R¹—NH₂, and paraformaldehyde. The first substituent R¹ may be subjected to the reaction after being protected in advance with a protecting group as needed. The reaction may be performed in the presence of a solvent. The solvent may be selected according to the type of the raw material. If necessary, the reaction may be performed under heating. The synthesized benzoxazine compound may be deprotected as needed. The synthesized benzoxazine compound is separated and/or purified by a known method as needed.

### (Polymerizable Compound)

If necessary, the curable material may contain a polymerizable compound other than the benzoxazine compound. Examples of the polymerizable compound include a compound that reacts with the polymerizable functional group of the benzoxazine compound to give a polymer. Examples of such a polymerizable compound include a compound having a polymerizable functional group (second polymerizable functional group) that reacts with the first polymerizable functional group of the benzoxazine compound. The polymerizable compounds may be used alone or in a combination of two or more.

Examples of the polymerizable compound include a monomer and/an oligomer. An oligomer refers to an oligomer including at least a repeating moiety of constituent units (having a number of repeating units of 2 or more), and is distinguished from a monomer.

Examples of the second polymerizable functional group include a functional group capable of reacting or polymerizing with at least the first polymerizable functional group by the action of radicals, cations, and/or anions generated from the polymerization initiator. Examples of such a second polymerizable functional group include a group having a polymerizable carbon-carbon unsaturated bond, an epoxy group, an isocyanate group, a hydroxy group, a mercapto group, an amino group, a ureido group, a carboxy group, a sulfonic acid group, an acid chloride group, and a chlorine atom. Examples of the group having a polymerizable carbon-carbon unsaturated bond include a vinyl group, an allyl group, a dienyl group, a (meth)acryloyloxy group, and a (meth)acrylamino group. The polymerizable compound may be either a monofunctional compound having one second polymerizable functional group, or a multifunctional compound having two or more second polymerizable functional groups.

The second polymerizable functional group is selected according to the type of the first polymerizable functional group. Examples of the combination of the first polymerizable functional group and the second polymerizable functional group include (a) a combination of a group having a polymerizable carbon-carbon unsaturated bond and a group having a polymerizable carbon-carbon unsaturated bond, (b) a combination of an epoxy group and an amino group, a hydroxy group or a carboxy group, (c) a combination of an isocyanate group and an amino group, a hydroxy group, or a carboxy group, (d) a combination of a hydroxy group and an epoxy group, an isocyanate group, or an amino group, (e) a combination of a mercapto group and an acid amide or a group having a polymerizable carbon-carbon unsaturated bond, and (f) a combination of an amino group and an epoxy group, an isocyanate group, a hydroxy group, a sulfonic acid group, a carboxy group, a chlorine atom, or an acid chloride group.

The proportion of the polymerizable compound in the curable material can be determined, for example, according to the type of the first polymerizable functional group, and the use of the cured product. The proportion of the polymerizable compound in the curable material is, for example, 0.1 mass % or more and 95 mass % or less (or 70 mass % or less), and may be 1 mass % or more and 95 mass % or less (or 70 mass % or less), or 10 mass % or more and 95 mass % or less (or 70 mass % or less). In these ranges, the upper limit value may be 50 mass % or less, or 30 mass % or less.

(Polymerization Initiator)

The polymerization initiator is activated by the action of heat or light, and initiates a reaction involving at least the first polymerizable functional group of the benzoxazine compound. The polymerization initiator is selected, for example, according to the type of the first polymerizable functional group, and the type of second polymerizable functional group. As the polymerization initiator, a polymerization initiator that generates radicals, cations, and/or anions by the action of heat or light is used, for example. Examples of the polymerization initiator include, but are not limited to, a radical polymerization initiator (an azo compound, a peroxide, an alkylphenone-series photopolymerization initiator, an acylphosphine oxide-series photopolymerization initiator, an intramolecular hydrogen extraction type photopolymerization initiator, an oxime ester-series photopolymerization initiator, etc.), an ion polymerization initiator (a sulfonic acid ester, a sulfonium salt, dicyandiamide, a iodonium salt, etc.). One of the polymerization initiators may be used, or two or more of the polymerization initiators may be used in a combination as needed.

The amount of the polymerization initiator is determined, for example, according to the ratio of the first polymerizable functional group of the benzoxazine compound, the ratio of the second polymerizable functional group of the polymerizable compound, and/or the desired curing rate. The amount of the polymerization initiator in the curable material is, for example, 0.001 mass % or more, and may be 10 mass % or less (or 5 mass % or less).

(Polymerization Catalyst)

If necessary, the curable material may contain a polymerization catalyst that promotes the curing reaction of the benzoxazine ring. Examples of the polymerization catalyst include an acid catalyst (a protonic acid, etc.), a basic catalyst. As these polymerization catalysts, known catalysts used for polymerization of benzoxazine compounds can be used. Examples of the acid catalyst include an organic carboxylic acid (citric acid, salicyl acid, benzoic acid, etc.), and phenols (phenol, etc.). It is also possible to use an aromatic carboxylic acid, an oxy carboxylic acid, and the like. As the basic catalyst, it is preferable to use an organic base (amine, a nitrogen-containing cyclic compound, etc.). Preferably, the polymerization catalyst is less volatile. The polymerization catalysts may be used alone or in a combination of two or more.

The proportion of the polymerization catalyst in the curable material is, for example, 0.1 mass % or more and 20 mass % or less, and may be 0.5 mass % or more and 10 mass % or less.

(Aromatic Compound Having Electron-Donating Substituent)

If necessary, the curable material may contain an aromatic compound having an electron-donating substituent (third substituent). In this case, it is possible to suppress the generation of cracks and/or voids in the cured product. The polymerization of the benzoxazine compound proceeds as a result of the benzene ring of another benzoxazine compound nucleophilically attacking a carbocation generated by ring opening of the benzoxazine ring. When such polymerization is performed in the presence of an aromatic compound having a third substituent, the aromatic compound is incorporated into the molecule of the polymer as a result of the aromatic ring of the aromatic compound nucleophilically attacking the carbocation. It is considered that this increases the flexibility of the polymer, thus suppressing the generation of cracks and voids.

Examples of the third substituent include a hydroxy group, an alkoxy group, a hydroxyalkyl group, a mercapto group, an alkylthio group, a mercapto alkyl group, an amino group, an aminoalkyl group, and an alkyl group. The number of carbon atoms in the third substituent is, for example, 1 to 8, and may be 1 to 7, or 1 to 6. The amino group also includes, in addition to a free amino group, a substituted amino group (e.g., an alkylamino group, a dialkylamino group, etc.). The third substituent may be linear or branched. The aromatic compound may have at least one third substituent, or may have two or more third substituents. The number of third substituents in the aromatic compound is selected according to the number of carbon atoms in the aromatic compound, and is, for example, 1 to 6, and may be 1 to 4 or 1 to 3, or 1 or 2.

The aromatic compound may have at least one arene ring, or may have two or more arene rings. The two or more arene rings may be linked by a direct bond, or may be linked via a linking group. Examples of the arene ring include a C₆₋₂₀ arene ring (e.g., a benzene ring, a naphthalene ring, an anthracene ring, a phenanthrene ring, etc.). Examples of the linking group include the groups listed as the examples of the first linking group.

The proportion of the above-described aromatic compound in the curable material is, for example, 0.1 mass % or more and 50 mass % or less (or 40 mass % or less), and may be 0.5 mass % or more and 35 mass % or less, or may be 1 mass % or more (or 5 mass % or more) and 30 mass % or less, or may be 1 mass % or more (or 5 mass % or more) and 20 mass % or less, or may be 10 mass % or more and 40 mass % (or 30 mass %) or less. When the proportion of the aromatic compound is in such a range, it is possible to more effectively suppress the generation of cracks and voids, while ensuring high mechanical strength. Furthermore, a high Tg can be easily ensured.

(Others)

The curable material may further contain an additional known curable resin (a thermosetting resin or a photocurable resin). Examples of such an additional curable resin include a carbodiimide compound, a triazine thiol compound, a bismaleimide compound, an epoxy resin, an oxetane resin, a thermosetting modified polyphenylene ether resin, a thermosetting polyimide resin, a silicone resin, a melamine resin, a urea resin, an allyl resin, a phenol resin, an unsaturated polyester resin, a bismaleimide-triazine resin, an alkyd resin, a furan resin, a polyurethane resin, and an aniline resin. The curable material may contain one, or two or more of these additional curable resins.

The curable material may contain a solvent and a known additive for resins (e.g., a reinforcing material, a filler, a plasticizer, a colorant, a pigment, a release agent, a flame retardant, a flame retardant auxiliary, a nucleating agent, an antioxidant, a heat stabilizer, a light stabilizer, an ultraviolet absorber, a lubricant, an antistatic agent, etc.). The curable material may contain one additive, or two or more additives.

The viscosity at 25° C. of the curable material is, for example, 20 mPa·s or more and 1,000 mPa·s or less. By using a benzoxazine compound including at least a compound having one benzoxazine ring in one molecule, it is possible to keep the viscosity of the curable material as low as 20 mPa·s or more and 500 mPa·s or less (preferably 300 mPa·s or less), and also suppress the generation of voids while ensuring high mechanical properties and high heat resistance of the cured product.

Note that the viscosity of the curable material can be measured, for example, using a cone-plate E type viscometer, at a rotational speed of 100 rpm.

### (Cured Product)

The cured product according to an aspect of the present invention is a cured product of the above-described curable material, and it is possible to achieve a high curing rate for the cured product by reacting the first polymerizable functional group and performing a ring-opening reaction of the oxazine ring. The curing rate of the cured product is 60% or more, and may be 70% or more, or 80% or more. Since a high curing rate can be achieved in this manner, it is possible to ensure high mechanical properties. Note that the curing rate is usually 100% or less.

The mechanical properties of the cured product can be evaluated, for example, with the flexural strength or the like. The flexural strength is, for example, 100 MPa or more, and may be 130 MPa or more, or 150 MPa or more. The flexural strength may be 300 MPa or less, for example.

Note that the flexural strength of the cured product was measured in accordance with JIS K 7171:2016, using a test strip 80 mm long, 10 mm wide, and 4 mm thick by using a universal tester manufactured by Intron Corporation

Since a high curing rate can be achieved, the heat resistance of the cured product is also high. The Tg of the cured product is, for example, 180° C. or more, and may be 200° C. or more, or 220° C. or more. The upper limit of the Tg of the cured product is not particularly limited, but is, for example, 380° C. or less, and may be 350° C. or less, or 300° C. or less.

The Tg of the cured product may be 180° C. or more (or 200° C. or more) and 380° C. or less, 220° C. or more and 380° C. or less, 180° C. or more and 350° C. or less (or 300° C. or less), or 200° C. or more and 350° C. or less (or 300° C. or less), or 220° C. or more and 350° C. or less (or 300° C. or less).

The Tg of the cured product is, for example, a Tg measured for a cured product of the curable material, using a commercially available dynamic mechanical analyzer (DMA). More specifically, the Tg of the cured product of the curable material can be determined from the temperature of a peak (top peak) at which the tan δ is a maximum when measuring the viscoelasticity of the cured product while increasing the temperature from the low-temperature side to the high-temperature side (e.g., from 0° C. to +380° C.).

The heat resistance can also be evaluated with the 5% weight loss temperature (Td5) or the residual carbon ratio.

The Td5 of the cured product is, for example, 200° C. or more, and may be 220° C. or more, or 230° C. or more. The Td5 is, for example, 450° C. or less, and may be 380° C. or less, 350° C. or less, or 300° C. or less.

The Td5 of the cured product may be 200° C. or more and 450° C. or less (or 380° C. or less), 220° C. or more and 450° C. or less (or 380° C. or less), 230° C. or more and 450° C. or less (or 380° C. or less), 200° C. or more and 350° C. or less (or 300° C. or less), 220° C. or more and 350° C. or less (or 300° C. or less), or 230° C. or more and 350° C. or less (or 300° C. or less).

The Td5 of the cured product can be determined from a thermogravimetric curve measured using a commercially available thermogravimetric analyzer (TGA).

The residual carbon ratio of the cured product is, for example, 30% or more, and preferably 40% or more. The residual carbon ratio is, for example, 60% or less.

Note that the residual carbon ratio of the cured product can be measured using a commercially available differential thermal balance.

### [Method for Producing Cured Product]

The cured product according to the above-described aspect of the present invention is produced by a production method including: a first step of heating or exposing to light a curable material, thereby reacting a first polymerizable functional group; and a second step of heating a reaction product obtained in the first step, thereby obtaining a cured product using ring opening of an oxazine ring. By performing the reaction of the first polymerizable functional group and the curing reaction using ring opening of the oxazine ring under conditions that are respectively suitable for these reactions, it is possible to ensure a high curing rate for the cured product. Even when the benzoxazine compound has only one oxazine ring, it is possible to allow the reaction of the first polymerizable functional group to proceed sufficiently, and it is thus possible to suppress the reduction in mechanical properties and heat resistance due to fewer crosslinking points. In addition, decomposition and vaporization are suppressed by using the above-described benzoxazine compound, and it is thus possible to suppress the generation of voids in the cured product.

### (First Step)

In the first step, the first polymerizable reactive group is reacted by heating or exposing the curable material to light. In the reaction in the first step, the benzoxazine compound may be polymerized to increase the molecular weight thereof by a reaction involving at least the first polymerizable reactive group. When the curable material contains a polymerizable compound having a second polymerizable functional group, the first polymerizable reactive group and the second polymerizable reactive group may be reacted in the first step.

By heating or exposing to light the curable material at a temperature lower than the temperature at which ring opening of the benzoxazine compound occurs, it is possible to react the first polymerizable reactive group (additionally, the second polymerizable functional group as needed). The temperature (first temperature) in the first step is preferably less than 180° C., and may be 175° C. or less, or 165° C. or less. At such a temperature, the reaction involving the first polymerizable functional group can be allowed to proceed preferentially, while the ring opening of the oxazine ring is suppressed. The first temperature is, for example, 10° C. or more, and may be 20° C. or more. In the case of heating the curable material in the first step, the first temperature is, for example, 40° C. or more, and may be 60° C. or more, or 80° C. or more, or may be 100° C. or more. At such a temperature, the reaction involving the first polymerizable functional group can be more efficiently performed by heating. These upper and lower limit values can be combined in any combination. In the case of exposing the curable material to light in the first step, the first temperature may be 10° C. or more and 40° C. or less, or 20° C. or more and 35° C. or less.

The first temperature may be 10° C. or more (or 20° C. or more) and less than 180° C., 10° C. or more (or 20° C. or more) and 175° C. or less, 10° C. or more (or 20° C. or more) and 165° C. or less, 40° C. or more (or 60° C. or more) and less than 180° C., 40° C. or more (or 60° C. or more) and 175° C. or less, 40° C. or more (or 60° C. or more) and 165° C. or less, 80° C. or more (or 100° C. or more) and less than 180° C., 80° C. or more (or 100° C. or more) and 175° C. or less, 80° C. or more (or 100° C. or more) and 165° C. or less, 10° C. or more and 40° C. or less, or 20° C. or more and 35° C. or less.

The heating in the first step may be performed in one step at a constant temperature, or may be performed while raising the temperature as needed. The temperature raising may be performed stepwise (e.g., in two to four steps), or may be performed continuously (e.g., at a predetermined temperature rising rate).

The heating time in the first step can be determined, for example, according to the type of the polymerization initiator, the type of the first polymerizable functional group (and the second polymerizable functional group as needed), and the desired curing rate and the use of the cured product. The heating time is, for example, 0.5 hours or more and 24 hours or less, and may be 1 hour or more and 10 hours or less, or 2 hours or more and 6 hours or less.

In the case of exposing the curable material to light in the first step, the light exposure time can be determined, for example, according to the type of the polymerization initiator, the type of the first polymerizable functional group (and the second polymerizable functional group as needed), and the desired curing rate and the use of the cured product. The light exposure time is, for example, 1 second or more and 0.5 hours or less, 5 seconds or more and 10 minutes or less, or 10 seconds or more and 5 minutes or less.

The first step may be performed under reduced or increased pressure, but is usually performed under atmospheric pressure. The first step may be performed in air, or under an inert gas atmosphere.

### (Second Step)

In the second step, a reaction product obtained in the first step is heated at a temperature that is higher than 150° C. and higher than the first temperature, thereby obtaining a cured product. By performing heating at such a temperature, the oxazine ring is opened to allow a curing reaction to proceed, and a cured product having a high curing rate is obtained.

The heating temperature (second temperature) in the second step may be selected from temperatures higher than 150° C., for example, according to the first temperature, and the presence or absence and the type of the catalyst. The second temperature is, for example, 155° C. or more, and may be higher than 160° C. (e.g., may be 165° C. or more), or higher than 170° C. (e.g., may be 175° C. or more), or may be 180° C. or more. By performing heating at such a temperature, it is possible to efficiently perform the ring-opening reaction of the oxazine ring. The second temperature is, for example, 380° C. or less, and may be 350° C. or less, 320° C. or less, 250° C. or less, or 220° C. or less. At such a temperature, it is possible to suppress side reactions, and more effectively suppress the generation of voids in the cured product. These lower and upper limit values can be combined in any combination.

The heating in the second step may be performed in one step at a constant temperature, or may be performed while raising the temperature as needed. The temperature raising may be performed stepwise (e.g., in two to four steps), or may be performed continuously (e.g., at a predetermined temperature rising rate). For example, after performing heating at a temperature that is higher than 150° C. and less than or equal to 200° C., heating may be performed at a temperature that is higher than this temperature and less than or equal to 380° C. (or less than or equal to 350° C. (e.g., less than or equal to 250° C.)).

The heating time in the second step can be determined, for example, according to the presence or absence of a catalyst, the type of the catalyst, and the desired curing rate and the use of the cured product. The heating time is, for example, 0.5 hours or more and 24 hours or less, and may be 1 hour or more and 10 hours or less, or 2 hours or more and 6 hours or less.

The heating may be performed under reduced or increased pressure, but is usually performed under atmospheric pressure. The heating may be performed in air, or under an inert gas atmosphere.

### [Polymer Composition]

The present invention also encompasses a polymer composition containing a polymer including repeating units of a polymerizable monomer having a benzoxazine ring. Such a polymer composition is obtained by using at least a polymerizable monomer (benzoxazine compound) having a benzoxazine ring and also having a polymerizable functional group (third polymerizable functional group), and preferentially polymerizing (or reacting) the third polymerizable functional group. For such a polymer composition, it is possible to increase the curing rate of the resulting cured product by polymerizing the third polymerizable functional group in advance. Accordingly, it is possible to ensure high mechanical properties and high heat resistance. In addition, the decomposition of the third polymerizable functional group or the vaporization of a decomposed product is suppressed, so that it is possible to suppress the generation of voids in the cured product.

The third polymerizable functional group can be selected from the above listed examples of the first polymerizable functional group. As the polymerizable monomer, a polymerizable monomer having a third polymerizable functional group and a benzoxazine ring is used. Preferably, the third polymerizable functional group is bonded to the benzoxazine ring. Examples of the preferred polymerizable monomer include the above-described benzoxazine compound (i.e., a benzoxazine compound having the first polymerizable functional group on the nitrogen atom constituting the oxazine ring). Therefore, the polymer composition also encompasses a reaction product obtained by the first step of the above-described method for producing a cured product.

The polymer may have the benzoxazine ring in a main chain, but preferably has the benzoxazine ring in a side chain. For a polymer having a benzoxazine ring in a side chain, the reactivity of ring opening of the benzoxazine ring can be easily maintained, so that the curing reaction can be performed using the ring opening, and a high curing rate can be easily achieved.

More specifically, the polymer preferably contains a main chain of the polymer, the benzoxazine ring, and a linking group (third linking group) that links a nitrogen atom constituting the benzoxazine ring and the main chain of the polymer. The main chain of the polymer and the third linking group are formed, for example, by the reaction of the first polymerizable functional group, and the reaction between the first polymerizable functional group and the second polymerizable functional group. Therefore, examples of the third linking group include the above-described second linking group. In such a polymer, the nitrogen atom in the benzoxazine ring is bonded to the main chain via the linking group, and it is therefore possible to more effectively suppress the generation of voids in the cured product.

In such a polymer, the benzoxazine ring is unreacted, and therefore a curing exotherm due to curing of the benzoxazine ring is observed by DSC of the polymer composition (cured product). Accordingly, the curing rate of the polymer composition is lower than the curing rate of the cured product, and is, for example, 75% or less, and may be 60% or less (or less than 60%), or 55% or less. The curing rate of the polymer composition is determined, in a manner similar to that in the case of determining the curing rate of the cured product of the curable material, from the amount of heat generation E₂ per unit mass measured by DSC using a test strip obtained by heating the polymer composition at 80° C. for 30 minutes, and the amount of heat generation E₀ per unit mass of the curable material at complete cure, by the following formula:

Curing rate (%)=(1−E₂/E₀)×100

In the polymer composition, the curing of the benzoxazine ring has not proceeded, and therefore the polymer composition is easily dissolved in a solvent. The rate of dissolution in solvent of the polymer composition can be evaluated, for example, with the mass reduction rate of the polymer composition in tetrahydrofuran (THF). The rate of dissolution in solvent is 0.1 mass % or more, and may be 3 mass % or more, or 5 mass % or more. The rate of dissolution in solvent of the polymer composition is measured as follows. First, the polymer composition is heated at 80° C. for 30 minutes, to produce a test strip (10 mm×10 mm×4 mm), which is then dried at 80° C. for 1 hour, and the mass (m₀) of the test strip is measured. The test strip is placed in 10 mL of THF, and allowed to stand at 60° C. for 3 days. The test strip is removed, then dried at 80° C. for 1 hour, and the mass (m₁) of the test strip is measured. The rate of dissolution in solvent can be determined from the following formula:

Rate of dissolution in solvent(mass %)=(m₀−m₁)/m₀×100

In contrast, a cured product obtained by further reacting the benzoxazine ring of the polymer composition (e.g., a cured product of the above-described curable material or a cured product obtained by the second step of the above-described production method) has a high curing rate. The rate of dissolution in solvent obtained in a manner similar to that described above using the cured product of the curable material in place of the above-described test strip is 1 mass % or less (preferably 0.1 mass % or less), and it is also possible to ensure a low rate of dissolution in solvent of less than 0.05 mass %.

### EXAMPLES

Hereinafter, the present invention will be specifically described by way of examples and comparative examples. However, the present invention is not limited to the following examples.

### Examples 1 to 3 and Comparative Examples 1 to 4

Thermosetting materials were prepared by mixing the benzoxazine compounds, and polymerization initiators as needed, shown in Table 1 or 2 at the ratios shown in the tables. Cured products were obtained by reacting the thermosetting materials by performing the first step, and the second step as needed, using the temperatures and the times shown in the tables. Dicumyl peroxide was used as the polymerization initiator.

The following evaluations (1) to (6) were performed using the thermosetting materials or the cured products. For Examples 1 to 3, the following evaluations (7) and (8) were performed using the reaction products (polymer compositions) obtained in the first step.

### (1) Viscosity of Thermosetting Material

The viscosity of each of the thermosetting materials was measured using an E type viscometer (TVE-20H, Told Sangyo Co., Ltd.) at 25° C. and a rotational speed of 20 rpm.

### (2) External Appearance

The external appearance of each of the cured products was evaluated according to the following criteria:

A: The cured product showed almost no void or crack, and had a smooth external appearance.

B: The cured product showed many voids and/or cracks.

### (3) Flexural Strength, Flexural Modulus, and Flexural Strain

The flexural strength (MPa) was determined in accordance with JIS K 7171:2016, using the previously described procedure.

The flexural modulus (MPa) and the flexural strain (%) were also measured in accordance with JIS K 7171:2016, using the same test strip as that used for the measurement of the flexural strength, under the same conditions as those used for the measurement of the flexural strength.

### (4) Tg

Each of the cured products was heated from 0° C. to +300° C. using a DMA (DMS 6100, manufactured by Hitachi High-Tech Science Corporation), at a frequency of 1 Hz and a temperature rising rate of 5° C./min. The temperature at which the tan δ was at the top peak was determined as the Tg of the cured product.

### (5) Reaction Rate (Curing Rate)

The curing rate of each of the cured products was determined using the previously described procedure.

### (6) Solubility in Solvent

The solubility (mass reduction rate) (%) in THF of each of the cured products was examined using the previously described procedure.

### (7) Reaction Rate (Curing Rate) of Polymer Composition

The curing rate of each of the polymer compositions obtained in the first step was determined using the previously described procedure.

### (8) Solubility in Solvent of Polymer Composition

The solubility (mass reduction rate) (%) in THF of each of the polymer compositions obtained in the first step was examined using the previously described procedure.

The results are shown in Tables 1 and 2. In these tables, E1 to E3 correspond to Examples 1 to 3, and R1 to R4 correspond to Comparative Examples 1 to 4.

TABLE 1

| | | E1 | E2 | E3 |
|---|---|---|---|---|
| Benzoxazine compound | | 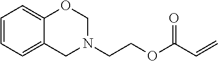 | 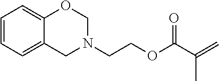 | 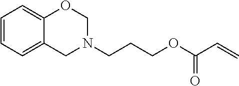 |
| (Parts by mass) | | 100 | 100 | 100 |
| Polymerization initiator | | 0.01 | 0.01 | 0.01 |
| (parts by mass) | | | | |
| First step | | 150° C. 4 h | 150° C. 4 h | 150° C. 4 h |
| Second step | | 180° C. 2 h | 180° C. 2 h | 180° C. 2 h |
| | | 220° C. 2 h | 220° C. 2 h | 220° C. 2 h |
| Viscosity (mPa · s) | | 230 | 276 | 182 |
| External appearance | | A | A | A |
| Flexural strength (MPa) | | 173 | 113 | 113 |
| Flexural modulus (MPa) | | 5094 | 4436 | 5664 |
| Flexural Strain (%) | | 3.6 | 2.6 | 2.0 |
| Tg (° C.) | | 240 | | |
| Curing | After first | 48 | 60 | 72 |
| rate (%) | step | | | |
| | After second | 100 | 98 | 85 |
| | step | | | |
| Rate of | After first | 45.6 | 0.4 | 5.8 |
| dissolution | step | | | |
| in solvent | After second | 0.0 | 0.0 | 0.0 |
| (%) | step | | | |

TABLE 2

| | R1 | R2 |
|---|---|---|
| Benzoxazine compound | 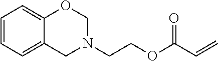 | 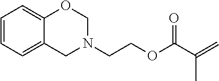 |
| (Parts by mass) | 100 | 100 |
| Polymerization | 0 | 0 |
| initiator | | |
| (parts by mass) | | |
| First step | 150° C. 4 h | 150° C. 4 h |
| Second step | — | — |
| Viscosity (mPa · s) | 230 | 276 |
| External appearance | A | A |
| Flexural strength | 23 | 51 |
| (MPa) | | |
| Flexural modulus | 658 | 4611 |
| (MPa) | | |
| Flexural Strain (%) | 7.1 | 1.1 |
| Curing rate (%) | 45 | 48 |
| Rate of dissolution | 55.2 | 1.0 |
| in solvent (%) | | |
| | R3 | R4 |
| Benzoxazine compound | 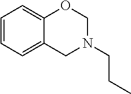 | 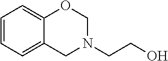 |
| (Parts by mass) | 100 | 100 |
| Polymerization | 0 | 0 |
| initiator | | |
| (parts by mass) | | |
| First step | 150° C. 4 h | 150° C. 4 h |
| Second step | 180° C. 2 h | 180° C. 2 h |
| | 220° C. 2 h | 220° C. 2 h |
| Viscosity (mPa · s) | | |
| External appearance | B | B |
| Flexural strength | | |
| (MPa) | | |
| Flexural modulus | | |
| (MPa) | | |
| Flexural Strain (%) | | |
| Curing rate (%) | | |
| Rate of dissolution | | |
| in solvent (%) | | |

As shown in Tables 1 and 2, in the examples, the generation of voids was suppressed, and flexural strengths higher than those achieved in the comparative examples were achieved. The reason for this is presumably that, in the examples, the decomposition of the benzoxazine compound was suppressed, and both of the reaction of the first polymerizable functional group and the ring-opening reaction of the oxazine ring had proceeded. As a result of both of the reaction of the first polymerizable functional group and the ring-opening reaction of the oxazine ring having proceeded, the cured products of the examples achieved curing rates higher than those achieved in the comparative examples, and also had lower rates of dissolution in solvent. Note that many voids were generated in Comparative Examples 3 and 4.

### Examples 4 and 5

Each of the steps was performed using the benzoxazine compounds shown in Table 3 in place of the benzoxazine compound of Example 1, and also using the temperatures and the times shown in Table 3. In the same manner as in Example 1 except for these changes, thermosetting materials were prepared, and cured products of the thermosetting materials were produced. In Table 3, E4 and E5 correspond to Examples 4 and 5, respectively.

For the thermosetting materials and the cured products of these examples as well, the same or similar evaluation results as those for Examples 1 to 3 are obtained.

TABLE 3

| | E4 | E5 |
|---|---|---|
| Benzoxazine compound | 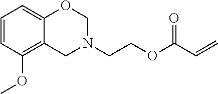 | 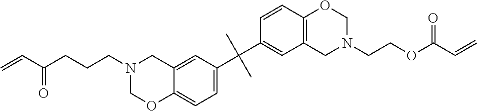 |
| (Parts by mass) | 100 | 100 |
| Polymerization | 0.01 | 0.01 |
| initiator | | |
| (parts by mass) | | |
| First step | 150° C. 4 h | 150° C. 4 h |
| Second step | 180° C. 2 h | 180° C. 2 h |
| | 220° C. 3 h | 220° C. 4 h |

### Examples 6 to 9

Furthermore, each of the steps was performed using an aromatic compound having an electron-donating substituent at the ratios shown in Table 4, and also using the temperatures and the times shown in Table 4. In the same manner as in Example 1 except for these changes, thermosetting materials were prepared, and cured products of the thermosetting materials were produced. In Table 4, E6 to E9 corresponds to Examples 6 to 9. In addition, the flexural strength, the flexural modulus, and the Tg were evaluated in the same manner as in Example 1 except that the obtained cured products were used. Note that 1,2-dimethoxy benzene was used as the aromatic compound having an electron-donating substituent.

The results are shown in Table 4. Table 4 also shows the results of Example 1.

TABLE 4

| | E1 | E6 | E7 | E8 | E9 |
|---|---|---|---|---|---|
| Benzoxazine compound | 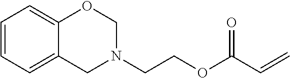 | | | | |
| (Parts by mass) | 100 | | | | |
| Polymerization initiator (parts by mass) | 0.01 | | | | |
| Aromatic compound (parts by mass) | 0 | 7 | 11 | 15 | 30 |
| First step | 150° C. 4 h | | | | |
| Second step | 180° C. 2 h | | | 180° C. 2 h | 180° C. 2 h |
| | 220° C. 2 h | | | 220° C. 3 h | 220° C. 2 h |
| External appearance | A | A | A | A | A |
| Flexural strength (MPa) | 173 | 162 | 201 | 179 | 130 |
| Flexural modulus (MPa) | 5094 | 5087 | 4830 | 4712 | 3875 |
| Tg (° C.) | 240 | 212 | 240 | 240 | 240 |

As shown in Table 4, when the aromatic compound having an electron-donating substituent was used, the generation of voids and cracks was suppressed while a high flexural strength and a high flexural modulus were ensured. The reason for this is presumably that the incorporation of the aromatic compound into the polymer during the ring-opening polymerization of the benzoxazine ring has increased the flexibility of the polymer. The cured products of the examples had a high Tg, and were highly heat resistant.

### Synthesis Example of Benzoxazine Compound

The benzoxazine compound used in Comparative Example 4 was synthesized using the following procedure. First, dioxane serving as a solvent and 2-amino ethanol were added into a reaction vessel, followed by stirring, and paraformaldehyde was added thereto. The resulting mixture was heated to 70° C., and phenol is added thereto, followed by stirring for 3 hours. The resulting mixture was concentrated, and then diluted by adding toluene thereto, followed by washing separately using hydrochloric acid at a concentration of 1 mol/L, distilled water, and saturated saline. The washed toluene solution was concentrated to give a benzoxazine compound. 2-ethanolamine, paraformaldehyde, and phenol were used at a mass ratio of approximately 1:2:1.

The benzoxazine compounds used in Examples 1, 6 to 9 and Comparative Example 1 were each synthesized by mixing the benzoxazine compound obtained in the same manner as in Comparative Example 4, methyl acrylate, and 4-methoxy phenol, and heating the mixture at 80° C. for 14 hours in the presence of dibutyltin oxide under a nitrogen atmosphere. The resulting reaction mixture was concentrated, and purified by column chromatography, to give the benzoxazine compounds used in Examples 1, 6 to 9 and Comparative Example 1. The benzoxazine compound having a hydroxyethyl group, methyl acrylate, 4-methoxy phenol, and dibutyltin oxide were used at a mass ratio of approximately 100:220:0.3:6.

The benzoxazine compounds used in Example 2 and Comparative Example 2 were obtained in the same manner as in Example 1 except that methyl methacrylate was used in place of methyl acrylate. The mass ratio of the components was adjusted as appropriate, taking the molar ratio of the components into consideration.

The benzoxazine compound used in Example 3 was synthesized in a manner similar to that in Example 1. First, a benzoxazine compound having a hydroxypropyl group on a nitrogen atom in an oxazine ring was obtained in the same manner as in Comparative Example 4 except that 3-amino-1-propanol was used in place of 2-amino ethanol. Then, except for using this benzoxazine compound, the benzoxazine compound used in Example 3 was obtained in the same manner as in Example 1. The mass ratio of the components was adjusted as appropriate, taking the molar ratio of the components into consideration.

The benzoxazine compound used in Comparative Example 3 was obtained in the same manner as in Comparative Example 4 except that propyl amine was used in place of 2-amino ethanol. The mass ratio of the components was adjusted as appropriate, taking the molar ratio of the components into consideration.

The benzoxazine compound used in Example 4 was synthesized in a manner similar to that in Example 1. First, a benzoxazine compound having a methoxy group in the 5-position and also having a hydroxypropyl group on a nitrogen atom in an oxazine ring was obtained in the same manner as in Comparative Example 4 except that 3-methoxy phenol was used in place of phenol. Then, except for using this benzoxazine compound, the benzoxazine compound of Example 4 was obtained in the same manner as in Example 1. The mass ratio of the components was adjusted as appropriate, taking the molar ratio of the components into consideration.

The benzoxazine compound used in Example 5 was synthesized in a manner similar to that in Example 1. First, a benzoxazine compound was obtained in the same manner as in Comparative Example 4 except that bisphenol A was used in place of phenol. Except for using the obtained benzoxazine compound, the benzoxazine compound used in Example 5 was obtained in the same manner as in Example 1. The mass ratio of the components was adjusted as appropriate, taking the molar ratio of the components into consideration.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

A cured product according to the above-described aspect of the present invention has excellent mechanical properties and high heat resistance, and the generation of voids in the cured product is suppressed. Accordingly, the cured product can be used in various applications with high mechanical properties and high heat resistance. Examples of such applications include, but are not particularly limited to, a material of a print wiring board of an electronic component, and a sealant (e.g., sealants of a semiconductor chip, a transistor, a capacitor, a coil, etc.).

1. A cured product of a curable material,
the curable material containing a benzoxazine compound and a polymerization initiator,
wherein
the benzoxazine compound has a polymerizable functional group on a nitrogen atom constituting an oxazine ring,
the curable material further contains an aromatic compound having at least one substituent selected from the group consisting of an alkoxy group, a hydroxy group, and an amino group, and
the cured product has a curing rate of 60% or more.

2. The cured product of a curable material according to claim 1,
wherein the benzoxazine compound includes at least a compound having one benzoxazine ring in one molecule.

3. The cured product of a curable material according to claim 1,
wherein the polymerizable functional group includes at least one selected from the group consisting of a group having a polymerizable carbon-carbon unsaturated bond, an epoxy group, an isocyanate group, a hydroxy group, a mercapto group, and an amino group.

4. The cured product of a curable material according to claim 1,
wherein the curable material contains, as the polymerizable functional group, at least a group having a polymerizable carbon-carbon unsaturated bond having four or more carbon atoms.

5. The cured product of a curable material according to claim 1,
wherein the polymerizable functional group is at least one selected from the group consisting of acryloyloxyalkyl, methacryloyloxyalkyl, acrylaminoalkyl, and methacrylaminoalkyl.

6. The cured product of a curable material according to claim 1,
wherein the cured product has a glass transition point of 180° C. or more.

7. (canceled)

8. A method for producing a cured product of a curable material: comprising:
a first step of heating or exposing to light, at a first temperature of less than 180° C., a curable material containing a benzoxazine compound having a polymerizable functional group on a nitrogen atom constituting an oxazine ring, a polymerization initiator, and an aromatic compound, thereby reacting the polymerizable functional group; and
a second step of heating a reaction product obtained in the first step at a second temperature that is higher than 150° C. and higher than the first temperature, to allow a curing reaction to proceed by ring opening of the oxazine ring, thereby obtaining a cured product, and
the aromatic compound has at least one substituent selected from the group consisting of an alkoxy group, a hydroxy group, and an amino group.

9. The method for producing a cured product of a curable material according to claim 8,
wherein the second temperature is 380° C. or less.

10. (canceled)

11. A polymer composition comprising a polymer including repeating units of a polymerizable monomer having a benzoxazine ring, which further comprises an aromatic compound having at least one substituent selected from the group consisting of an alkoxy group, a hydroxy group, and an amino group.

12. The polymer composition according to claim 11,
wherein the polymer has the benzoxazine ring in a side chain.

13. The polymer composition according to claim 11,
wherein the polymer includes a main chain of the polymer, the benzoxazine ring, and a linking group that links a nitrogen atom constituting the benzoxazine ring and the main chain of the polymer.

14. (canceled)

15. The cured product of a curable material according to claim 1, wherein the aromatic compound is incorporated into a molecule of a polymer constituting the cured product.

16. The cured product of a curable material according to claim 1, wherein the polymerization initiator includes a radical polymerization initiator.

17. The cured product of a curable material according to claim 1, wherein a flexural strength of the cured product is 100 MPa or more.

18. The cured product of a curable material according to claim 1, wherein the amount of the aromatic compound is 11 parts by mass or more relative to 100 parts by mass of the benzoxazine compound.

19. A cured product of a curable material,
the curable material containing a benzoxazine compound and a polymerization initiator,
wherein
the benzoxazine compound has a polymerizable functional group on a nitrogen atom constituting an oxazine ring,
the curable material further contains an aromatic compound having an electron-donating substituent,
the aromatic compound is incorporated into a molecule of a polymer constituting the cured product, and
the cured product has a curing rate of 60% or more.
